(19) United States
(12) Patent Application Publication
(10) Pub. No.: US 2017/0187553 A1
(43) Pub. Date: Jun. 29, 2017

(54) PHASE EQUALIZATION OF VERTICAL CAVITY SURFACE EMITTING LASER WITH LOW-PASS AND ALL-PASS FILTERING

(71) Applicant: Fujitsu Limited, Kawasaki-shi (JP)

(72) Inventor: Nikola Nedovic, San Jose, CA (US)

(21) Appl. No.: 14/980,486

(22) Filed: Dec. 28, 2015

(51) Int. Cl. H04L 25/03; H04B 10/50; H04B 10/58

(52) U.S. Cl. CPC H04L 25/03343; H04B 10/58; H04B 10/503

(57) ABSTRACT

A method and system for implementing phase-compensating equalization in an optical transmitter may employ a phase-compensating equalizer that includes an all-pass filter and a low-pass filter operating in parallel on an input signal to be transmitted in an optical communication network. The phase-compensating equalizer may include a circuit that combines the outputs of the two filters (e.g., through addition or subtraction) to generate an output of the equalizer. The output of the phase-compensating equalizer may be directed to a vertical cavity surface emitting laser (VCSEL) in the transmitter, and may compensate for at least a portion of the phase distortion resulting from the inherent phase characteristics of the VCSEL. The use of the phase-compensating equalizer may improve the phase response of an optical transmitter operating at data rates of tens of gigabits per second and beyond.

### BACKGROUND

Field of the Disclosure

The present disclosure relates generally to optical communication networks and, more particularly, to an optical transmitter that implements phase equalization for a vertical cavity surface emitting laser.

Description of the Related Art

Telecommunication, cable television and data communication systems use optical networks to rapidly convey large amounts of information between remote points. In an optical network, information is conveyed in the form of optical signals through optical fibers. Optical fibers may comprise thin strands of glass capable of communicating the signals over long distances. Optical networks often employ modulation schemes to convey information in the optical signals over the optical fibers. Such modulation schemes may include phase-shift keying (PSK), frequency-shift keying (FSK), amplitude-shift keying (ASK), pulse-amplitude modulation (PAM), and quadrature amplitude modulation (QAM).

Optical networks may also include various optical elements, such as amplifiers, dispersion compensators, multiplexer/demultiplexer filters, wavelength selective switches (WSS), optical switches, couplers, etc. to perform various operations within the network. In particular, optical networks may include optical-electrical-optical (O-E-O) regeneration at reconfigurable optical add-drop multiplexers (ROADMs) when the reach of an optical signal is limited in a single optical path.

As data rates for optical networks continue to increase, reaching up to 1 terabit/s (1 T) and beyond, the demands on optical signal-to-noise ratios (OSNR) also increase. Vertical Cavity Surface Emitting Lasers (VCSELs) are widely used in high speed optical communications. To improve the effective bandwidth and data rate of communication, optical networks often implement feed-forward type transmitter equalization.

### SUMMARY

In one aspect, a disclosed phase-compensating equalizer includes a low-pass filter that allows input signals having a frequency lower than a cutoff frequency to pass through the low-pass filter without attenuation, that attenuates input signals having a frequency higher than the cutoff frequency, and that generates, from a first input signal, a first intermediate output signal. The phase-compensating equalizer also includes an all-pass filter that alters phase characteristics of input signals without altering amplitude characteristics of the input signals, and that generates, from the first input signal, a second intermediate output signal whose amplitude characteristics are not dependent on frequency. The phase-compensating equalizer also includes a combining circuit that generates an output signal for the phase-compensating equalizer as a linear combination of the first intermediate output signal and the second intermediate output signal.

In any of the disclosed embodiments of the phase-compensating equalizer, the first input signal may be a signal to be transmitted in an optical communication network

In any of the disclosed embodiments of the phase-compensating equalizer, to generate the output signal of the phase-compensating equalizer, the combining circuit may subtract the second intermediate output signal from the first intermediate output signal.

In any of the disclosed embodiments of the phase-compensating equalizer, the low-pass filter and the all-pass filter may be implemented by respective analog circuits.

In any of the disclosed embodiments of the phase-compensating equalizer, the all-pass filter may add a varying amount of delay to the second intermediate output signal. The amount of the delay may vary as a function of the frequency of the first input signal.

In any of the disclosed embodiments of the phase-compensating equalizer, the low-pass filter may be implemented by a capacitive low-pass filter circuit.

In any of the disclosed embodiments of the phase-compensating equalizer, the low-pass filter may be implemented by an inductive low-pass filter circuit.

In any of the disclosed embodiments of the phase-compensating equalizer, the output of the phase-compensating equalizer may be an input to a vertical cavity surface emitting laser (VCSEL).

In any of the disclosed embodiments of the phase-compensating equalizer, the phase-compensating equalizer may compensate for phase distortion introduced by the VCSEL.

In a further aspect, a disclosed optical transmitter includes a phase-compensating equalizer that perform a low-pass filtering operation and an all-pass filtering operation on an input signal and that generates an output signal; and a vertical cavity surface emitting laser (VCSEL). The output signal of the phase-compensating equalizer may be directed to the VCSEL as input.

In any of the disclosed embodiments of the optical transmitter, the phase-compensating equalizer may include a first analog filter circuit that performs the low-pass filtering operation and generates a first intermediate output signal; a second analog filter circuit that performs the all-pass filtering operation and generates a second intermediate output signal; and a combining circuit that generates the output signal as a linear combination of the first intermediate output signal and the second intermediate output signal.

In any of the disclosed embodiments of the optical transmitter, to generate the output signal, the combining circuit may subtract the second intermediate output signal from the first intermediate output signal.

In any of the disclosed embodiments of the optical transmitter, the first analog filter circuit may allow input signals having a frequency lower than a cutoff frequency to pass through the low-pass filter without attenuation and may attenuate input signals having a frequency higher than the cutoff frequency.

In any of the disclosed embodiments of the optical transmitter, the second analog filter circuit may add a varying amount of delay to the second intermediate output signal. The amount of the delay may vary as a function of the frequency of the input signal.

In any of the disclosed embodiments of the optical transmitter, the phase-compensating equalizer may include a single analog filter circuit whose transfer function is equivalent to a combination of the respective transfer functions of a low-pass filter and an all-pass filter that operate in parallel.

In any of the disclosed embodiments of the optical transmitter, the phase-compensating equalizer may compensate for phase distortion introduced by the VCSEL.

In any of the disclosed embodiments of the optical transmitter, the phase-compensating equalizer may be one of a plurality of equalizers that condition the input signal.

In yet another aspect, a disclosed method is for phase equalization. The method may include designing a low-pass filter having initial circuit parameters, designing an all-pass filter having initial circuit parameters, and designing a phase-compensating equalizer in which the low-pass filter and the all-pass filter operate in parallel to condition an input signal and in which an output is generated as a linear combination of respective intermediate outputs generated by the low-pass filter and the all-pass filter. The initial circuit parameters of the low-pass filter may include an initial capacitance or inductance. The initial circuit parameters of the all-pass filter may include one or more initial RC constants.

In any of the disclosed embodiments, the method may include determining that the phase-compensating equalizer does not meet a target metric for compensating phase distortion introduced by a vertical cavity surface emitting laser (VCSEL), and modifying one of the initial circuit parameters of the low-pass filter or one of the initial circuit parameters of the all-pass filter, in response to the determination.

In any of the disclosed embodiments, the method may include receiving, by the phase-compensating equalizer, an input signal to be transmitted over an optical network; directing the input signal to a low-pass filter; generating, by the low-pass filter, a first intermediate output signal; directing the input signal to an all-pass filter; generating, by the all-pass filter, a second intermediate output signal; subtracting the second intermediate output signal from the first intermediate output signal to generate an output signal for the phase-compensating equalizer; and directing the output signal to a vertical cavity surface emitting laser (VCSEL) as input.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram of selected elements of an embodiment of an optical network, according to at least some embodiments;

FIG. 2 is a block diagram illustrating selected elements of a conventional feed-forward equalizer (FFE) that applies a delay at each stage of a delay line;

FIG. 3 illustrates an example of the ideal characteristics of a conventional feed-forward equalizer;

FIG. 4 is a block diagram illustrating selected elements of an equalizer that is to compensate for the phase characteristics of a VCSEL in an optical transmitter, according to at least some embodiments;

FIG. 5 is a block diagram illustrating an example implementation of an all-pass filter circuit that may be included in the equalizers described herein, according to at least some embodiments;

FIG. 6 is a block diagram illustrating an example implementation of a low-pass filter circuit that may be included in the equalizers described herein, according to at least some embodiments;

FIG. 7 is a flow diagram illustrating selected elements of a method of operation 700 of an equalizer that includes both a low-pass filter and an all-pass filter, according to at least some embodiments;

FIG. 8 is a flow diagram illustrating selected elements of a method 800 for designing an equalizer that compensates for the phase characteristics of a VCSEL in an optical transmitter, according to at least some embodiments;

FIGS. 9A and 9B illustrate example responses of a VCSEL for an unequalized PAM4 input signal; and

FIGS. 10A-10B illustrate an example of the effects of the phase equalization techniques disclosed herein on the response of a VCSEL for a PAM4 input signal.

### DESCRIPTION OF PARTICULAR EMBODIMENT(S)

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically or collectively. Thus, as an example (not shown in the drawings), device “12-1” refers to an instance of a device class, which may be referred to collectively as devices “12” and any one of which may be referred to generically as a device “12”. In the figures and the description, like numerals are intended to represent like elements.

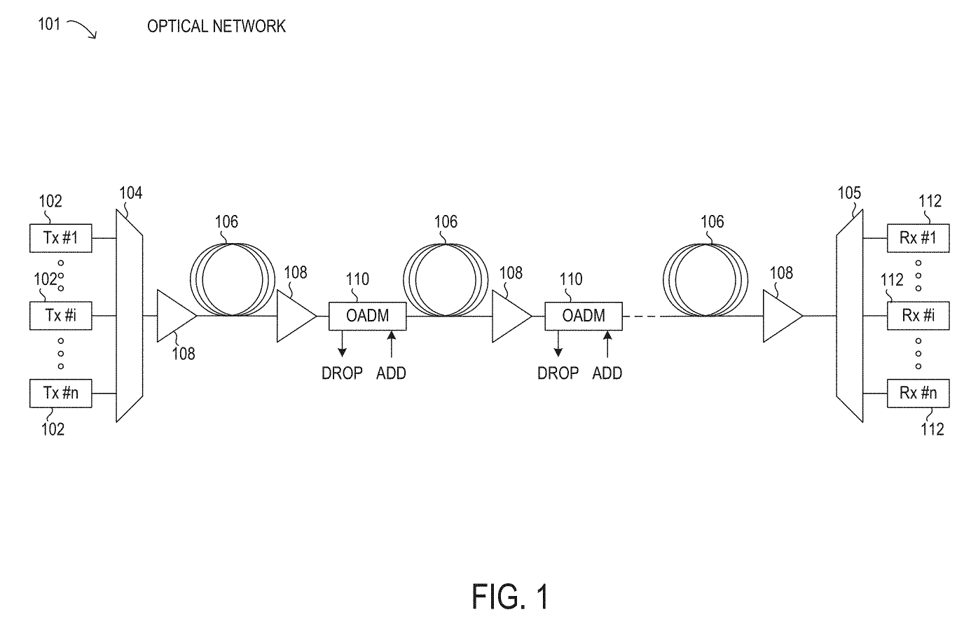

Referring now to the drawings, FIG. 1 illustrates an example embodiment of optical network 101, which may represent an optical communication system. Optical network 101 may include one or more optical fibers 106 to transport one or more optical signals communicated by components of optical network 101. The network elements of optical network 101, coupled together by fibers 106, may comprise one or more transmitters 102, one or more multiplexers (MUX) 104, one or more optical amplifiers 108, one or more optical add/drop multiplexers (OADM) 110, one or more demultiplexers (DEMUX) 105, and one or more receivers 112.

Optical network 101 may comprise a point-to-point optical network with terminal nodes, a ring optical network, a mesh optical network, or any other suitable optical network or combination of optical networks. Optical network 101 may be used in a short-haul metropolitan network, a long-haul inter-city network, or any other suitable network or combination of networks. The capacity of optical network 101 may include, for example, 100 Gbit/s, 400 Gbit/s, or 1 Tbit/s. Optical fibers 106 comprise thin strands of glass capable of communicating the signals over long distances with very low loss. Optical fibers 106 may comprise a suitable type of fiber selected from a variety of different fibers for optical transmission. Optical fibers 106 may include any suitable type of fiber, such as a Single-Mode Fiber (SMF), Enhanced Large Effective Area Fiber (E-LEAF), or TrueWave® Reduced Slope (TW-RS) fiber.

Optical network 101 may include devices to transmit optical signals over optical fibers 106. Information may be transmitted and received through optical network 101 by modulation of one or more wavelengths of light to encode the information on the wavelength. In optical networking, a wavelength of light may also be referred to as a channel that is included in an optical signal (also referred to herein as a “wavelength channel”). Each channel may carry a certain amount of information through optical network 101.

To increase the information capacity and transport capabilities of optical network 101, multiple signals transmitted at multiple channels may be combined into a single wideband optical signal. The process of communicating information at multiple channels is referred to in optics as wavelength division multiplexing (WDM). Coarse wavelength division multiplexing (CWDM) refers to the multiplexing of wavelengths that are widely spaced having low number of channels, usually greater than 20 nm and less than sixteen wavelengths, and dense wavelength division multiplexing (DWDM) refers to the multiplexing of wavelengths that are closely spaced having large number of channels, usually less than 0.8 nm spacing and greater than forty wavelengths, into a fiber. WDM or other multi-wavelength multiplexing transmission techniques are employed in optical networks to increase the aggregate bandwidth per optical fiber. Without WDM, the bandwidth in optical networks may be limited to the bit-rate of solely one wavelength. With more bandwidth, optical networks are capable of transmitting greater amounts of information. Optical network 101 may transmit disparate channels using WDM or some other suitable multi-channel multiplexing technique, and to amplify the multi-channel signal.

Optical network 101 may include one or more optical transmitters (Tx) 102 to transmit optical signals through optical network 101 in specific wavelengths or channels. Transmitters 102 may comprise a system, apparatus or device to convert an electrical signal into an optical signal and transmit the optical signal. For example, transmitters 102 may each comprise a laser and a modulator to receive electrical signals and modulate the information included in the electrical signals onto a beam of light produced by the laser at a particular wavelength, and transmit the beam for carrying the signal throughout optical network 101.

Multiplexer 104 may be coupled to transmitters 102 and may be a system, apparatus or device to combine the signals transmitted by transmitters 102, e.g., at respective individual wavelengths, into a WDM signal.

Optical amplifiers 108 may amplify the multi-channeled signals within optical network 101. Optical amplifiers 108 may be positioned before or after certain lengths of fiber 106. Optical amplifiers 108 may comprise a system, apparatus, or device to amplify optical signals. For example, optical amplifiers 108 may comprise an optical repeater that amplifies the optical signal. This amplification may be performed with opto-electrical or electro-optical conversion. In some embodiments, optical amplifiers 108 may comprise an optical fiber doped with a rare-earth element to form a doped fiber amplification element. When a signal passes through the fiber, external energy may be applied in the form of an optical pump to excite the atoms of the doped portion of the optical fiber, which increases the intensity of the optical signal. As an example, optical amplifiers 108 may comprise an erbium-doped fiber amplifier (EDFA).

OADMs 110 may be coupled to optical network 101 via fibers 106. OADMs 110 comprise an add/drop module, which may include a system, apparatus or device to add and drop optical signals (for example at individual wavelengths) from fibers 106. After passing through an OADM 110, an optical signal may travel along fibers 106 directly to a destination, or the signal may be passed through one or more additional OADMs 110 and optical amplifiers 108 before reaching a destination.

In certain embodiments of optical network 101, OADM 110 may represent a reconfigurable OADM (ROADM) that is capable of adding or dropping individual or multiple wavelengths of a WDM signal. The individual or multiple wavelengths may be added or dropped in the optical domain, for example, using a wavelength selective switch (WSS) (not shown) that may be included in a ROADM.

As shown in FIG. 1, optical network 101 may also include one or more demultiplexers 105 at one or more destinations of network 101. Demultiplexer 105 may comprise a system apparatus or device that acts as a demultiplexer by splitting a single composite WDM signal into individual channels at respective wavelengths. For example, optical network 101 may transmit and carry a forty (40) channel DWDM signal. Demultiplexer 105 may divide the single, forty channel DWDM signal into forty separate signals according to the forty different channels.

In FIG. 1, optical network 101 may also include receivers 112 coupled to demultiplexer 105. Each receiver 112 may receive optical signals transmitted at a particular wavelength or channel, and may process the optical signals to obtain (e.g., demodulate) the information (i.e., data) that is included in the optical signals. Accordingly, network 101 may include at least one receiver 112 for every channel of the network.

Optical networks, such as optical network 101 in FIG. 1, may employ modulation techniques to convey information in the optical signals over the optical fibers. Such modulation schemes may include phase-shift keying (PSK), frequency-shift keying (FSK), amplitude-shift keying (ASK), pulse-amplitude modulation (PAM), and quadrature amplitude modulation (QAM), among other examples of modulation techniques. In PSK, the information carried by the optical signal may be conveyed by modulating the phase of a reference signal, also known as a carrier wave, or simply, a carrier. The information may be conveyed by modulating the phase of the signal itself using two-level or binary phase-shift keying (BPSK), four-level or quadrature phase-shift keying (QPSK), multi-level phase-shift keying (M-PSK) and differential phase-shift keying (DPSK). In QAM, the information carried by the optical signal may be conveyed by modulating both the amplitude and phase of the carrier wave. PSK may be considered a subset of QAM, wherein the amplitude of the carrier waves is maintained as a constant.

Additionally, polarization division multiplexing (PDM) technology may provide achievement of a greater bit rate for information transmission. PDM transmission comprises independently modulating information onto different polarization components of an optical signal associated with a channel. In this manner, each polarization component may carry a separate signal simultaneously with other polarization components, thereby enabling the bit rate to be increased according to the number of individual polarization components. The polarization of an optical signal may refer to the direction of the oscillations of the optical signal. The term “polarization” may generally refer to the path traced out by the tip of the electric field vector at a point in space, which is perpendicular to the propagation direction of the optical signal.

In an optical network, such as optical network 101 in FIG. 1, it is typical to refer to a management plane, a control plane, and a transport plane (sometimes called the physical layer). A central management host (not shown) may reside in the management plane and may configure and supervise the components of the control plane. The management plane includes ultimate control over all transport plane and control plane entities (e.g., network elements). As an example, the management plane may include a central processing center (e.g., the central management host), including one or more processing resources, data storage components, etc. The management plane may be in electrical communication with the elements of the control plane and may also be in electrical communication with one or more network elements of the transport plane. The management plane may perform management functions for an overall system and provide coordination between network elements, the control plane, and the transport plane. As examples, the management plane may include an element management system (EMS) which handles one or more network elements from the perspective of the elements, a network management system (NMS) which handles many devices from the perspective of the network, and an operational support system (OSS) which handles network-wide operations.

Modifications, additions or omissions may be made to optical network 101 without departing from the scope of the disclosure. For example, optical network 101 may include more or fewer elements than those depicted in FIG. 1. Also, as mentioned above, although depicted as a point-to-point network, optical network 101 may comprise any suitable network topology for transmitting optical signals such as a ring, a mesh, and a hierarchical network topology.

As discussed above, the amount of information that may be transmitted over an optical network may vary with the number of optical channels coded with information and multiplexed into one signal. Accordingly, an optical fiber employing a WDM signal may carry more information than an optical fiber that carries information over a single channel. Besides the number of channels and number of polarization components carried, another factor that may affect how much information is transmitted over an optical network is the bit rate of transmission. The higher the bit rate, the greater the transmitted information capacity. Achieving higher bit rates may be limited by the availability of wide bandwidth electrical driver technology, digital signal processor technology and increases in the required OSNR for transmission over optical network 101.

As previously noted, Vertical Cavity Surface Emitting Lasers (VCSELs) are often used in high speed optical communications. Unlike other semiconductor lasers that are edge-emitting, VCSELs are semiconductor laser diodes that emit laser beams at an angle perpendicular to their top surface. In a VCSEL, the laser resonator includes two mirrors that are parallel to the wafer surface with one or more quantum wells for the laser light generation in between. VCSELs have a larger output aperture than most edge-emitting lasers, and produce a lower divergence angle of the output beam. For this and other reasons (including a low threshold current, and lower power consumption than most edge-emitting lasers), they are suitable for coupling with optical fibers. However, VCSELs typically have lower emission power than edge-emitting lasers and exhibit inherent nonlinearity. In addition, the response of a VCSEL may have exhibit a small amount of ripple, known as relaxation-oscillation. The time characteristics of this ripple are dependent on the VCSEL itself and also on the bias (i.e., the current used to the VCSEL).

As data rates for communication networks (including optical communication networks) continue to increase, inter-symbol interference (ISI) becomes a more significant problem than it was in communication networks operating at lower data rates. For example, at a data rate of 10 gigabits per second, ISI can cause complete eye closure within a very short distance (e.g., a few inches of trace on a printed circuit board, a few feet of copper cable, or a few dozen yards of multimode optical fiber). The ISI can also change over time with changing physical conditions, such as changes in temperature, the bending of a printed circuit board or cable, or the presence (or an increase) in vibrations in the system. In some systems, in an attempt to mitigate the effects of ISI, a filter may be applied to flatten the frequency response of the channel. This process, which may be referred to, generally, as equalization, can be applied at either the transmitters or receivers in a communication network. When equalization is applied at the transmitter it may sometimes be referred to as a “pre-emphasis” or “de-emphasis” improvement. Pre-emphasis often used in channels where the channel response is sufficiently well known in advance (e.g., in copper cables).

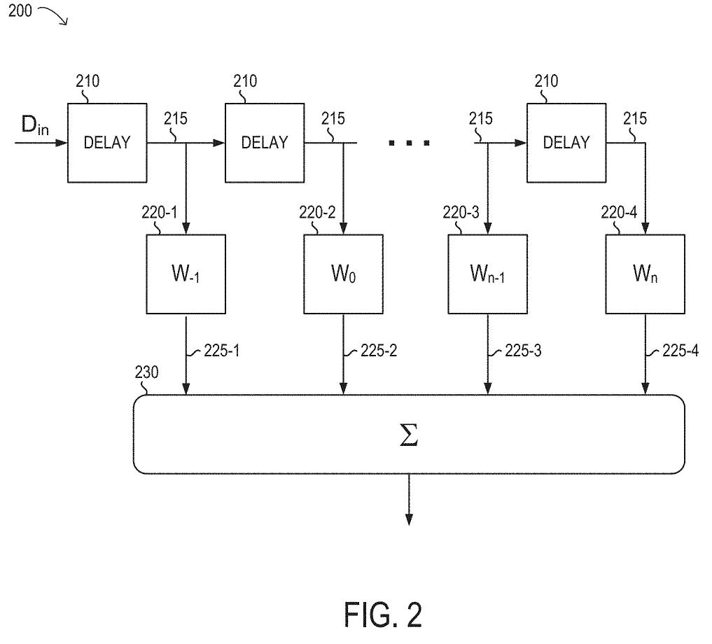

To improve the effective bandwidth and data rate, communication networks often employ one or more equalization techniques, all of which come with different engineering trade-offs, including trade-offs in power consumption, performance, and/or cost. One approach that is commonly used in communications networks is feed-forward equalization. This approach typically includes a finite impulse response filter (FIR) with a series of tap weights that are programmed to adjust the impulse response and the frequency response of an input signal. A feed-forward equalizer may be implemented entirely in the analog domain. This approach may be used in very high speed communication networks with relatively low power consumption. However, the performance of feed-forward equalization is, in most cases, insufficient for optical networks operating the range of tens of gigabits per second. An example implementation of a conventional feed-forward equalizer is illustrated in FIG. 2 and described below.

FIG. 2 is a block diagram illustrating selected elements of a conventional feed-forward equalizer (FFE) 200 that applies a delay at each stage of a delay line. In this example, equalizer 200 includes multiple delay elements 210 and corresponding tap weighting elements 220, as well as a combiner circuit 230. Each of the delay elements 210 applies a delay to its input signal to generate a delayed output signal 215 that is directed to the next delay element in the delay line (if any exists) as input.

As illustrated in FIG. 2, the delayed output signal 215 from each of the delay elements 210 is tapped and directed to a respective one of the tap weighting elements 220. In this example, the input to the equalizer, which is labeled Dᵢₙ, is directed to the first delay element in the delay line. The output 215 of the first delay element 210 is directed to weighting element 220-1 (labeled as W₋₁) and to the second delay element 210 in the delay line. Similarly, the output 215 of the second delay element 210 is directed to weighting element 220-2 (labeled as W₀) and to the next delay element in the delay line (not shown). In this example, the output 215 of the penultimate delay element is directed to weighting element 220-3 (labeled as Wₙ₋₁) and to the last delay element 210 in the delay line. The output 215 of the last delay element 210 is directed to weighting element 220-4 (which is labeled Wₙ.

In this example, each of the tap weighting elements 220 may multiply the output 215 of one of the delay elements 210 by a tap-specific weight to generate a respective weighted delayed output 225 and may direct that weighted delayed output to combiner circuit 230. In some embodiments, the weighting applied to two or more of the taps may be different from each other. For example, weighting element 220-1 (labeled W₋₁) may apply a tap-specific weight to a delayed output signal 215 to generate a weighted delayed output 225-1. Similarly, weighting element 220-2 (labeled W₀) may apply a tap-specific weight to a delayed output signal 215 to generate weighted delayed output 225-2; weighting element 220-3 (labeled Wₙ₋₁) may apply a tap-specific weight to a delayed output signal 215 to generate weighted delayed output 225-3; and weighting element 220-4 (labeled Wₙ) may apply a tap-specific weight to a delayed output signal 215 to generate a weighted delayed output 225-4.

In the example embodiment illustrated in FIG. 2, combiner circuit 230 may generate an output for equalizer 200 (labeled as Dₒᵤₜ) through the linear combination of the weighted delayed outputs 225. For example, Dₒᵤₜ may be generated as the sum of the weighted delayed outputs 225, in some embodiments. In other embodiments, combiner circuit 230 may generate Dₒᵤₜ using another combination of the weighted delayed outputs 225.

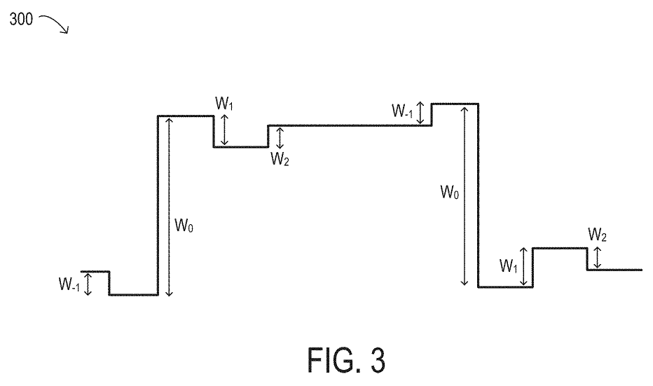

FIG. 3 illustrates an example of the ideal characteristics of a conventional feed-forward equalizer (such as that illustrated in FIG. 2) for an input signal that transitions from 0 to 1 and then from 1 to 0. For example, the waveform 300 illustrated in FIG. 3 includes, for the rising transition, contributions from each of four tap weighing elements, the amplitudes of which are shown as the first set of labels W-1, W0, W1, and W2. The waveform 300 illustrated in FIG. 3 also includes, for the falling transition, contributions from each of four tap weighing elements, the amplitudes of which are shown as the second set of labels W-1, W0, W1, and W2.

The use of feed-forward equalization may compensate for some nonlinearities inherent in a VCSEL in an optical transmitter. However, in some cases, the use of feed-forward equalization may distort the phase response and group delay for the VCSEL, which, in addition to the phase distortion introduced by the VCSEL itself, may be associated with inter-symbol interference (ISI). In other words, rather than improving the phase distortion of the optical transmitter, the use of delay elements (such as those included in a linear feed-forward equalizer) may actually distort the phase response even further and/or may result in residual error or interference. Shorter delays may reduce this effect, but may also reduce the equalization amplitude and DC gain. One prior approach for addressing phase distortion in an optical transmitter that includes a VCSEL employs a phase equalization unit that behaves as a continuous time linear peaking equalizer (CTLE). This existing phase equalization unit alters both the phase response and the amplitude response.

Note that, as discovered based on observations and characterizations of the responses of optical communication circuits that include VCSELs, it may often be the case that the amplitude characteristics of a VCSEL have enough bandwidth for operation at high data rates, and what limits the performance at high data rates may be its phase characteristics.

In at least some embodiments of the present disclosure, phase equalization may be implemented in an optical transmitter by an equalizer that includes an all-pass filter circuit (e.g., an analog circuit that performs all-pass filtering) in parallel with a low-pass filter circuit. The low-pass filter circuit may, dependent on a particular combination of capacitive, inductive, and/or resistive elements, allow input signals having a frequency lower than a particular cutoff frequency to pass through the filter with little or no attenuation, and may attenuate input signals having a frequency higher than the cutoff frequency. In some embodiments, the all-pass filter may alter the phase characteristics of the input signal that is to be transmitted by the optical transmitter, but not change the amplitude characteristics of the signal. More specifically, the all-pass filter may vary its phase shift (adding varying amounts of delay to the output signal produced by the filter) as a function of frequency. The all-pass filter may, in various embodiments, be implemented using any of a variety of types of filters for which the amplitude characteristics do not depend on frequency. For example, if a sinusoidal signal is sent to the all-pass filter, and the frequency of this input signal varies, the output may also be a sinusoidal signal and the amplitude of the output signal may not change regardless of the frequency of the input signal. However, the phase response (e.g., the delay between the input and output) may vary as a function of the frequency.

In some embodiments, the phase-compensating equalizer may compensate for some or all of the phase distortion caused by the phase characteristics of a VCSEL in the optical transmitter. The phase-compensating equalizers described herein may, in various embodiments, be introduced into a transmitter at in the optical communication network (such as one of transmitters 102 in FIG. 1) and/or at any other link within the optical communication network. In some embodiments, the output of the phase-compensating equalizer may be directed to an input of a VCSEL of an optical transmitter in an optical communication network, such as one of the transmitters 102 illustrated in FIG. 1. For example, the optical network 101 may include a respective instance of a phase-compensating equalizer for each one of multiple optical channels. In some embodiments of the present disclosure, a phase-compensating equalizer may be introduced into an optical communication network instead of (and in substantially the same position in the network as) an FFE is positioned to condition an input for a VCSEL in some existing optical communication networks.

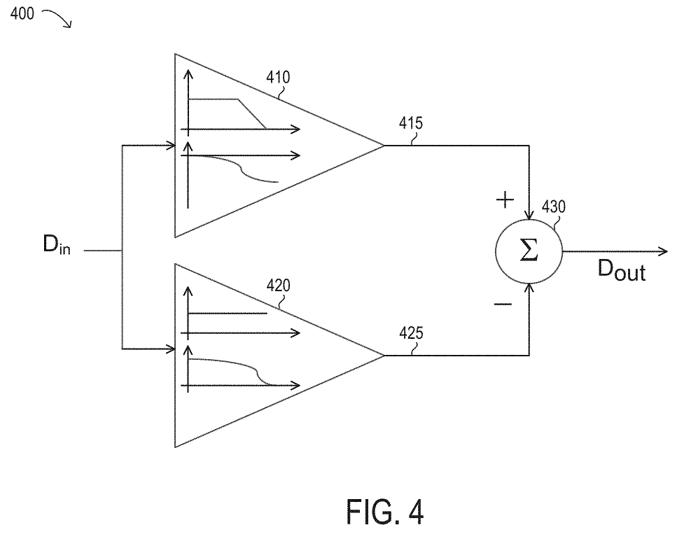

FIG. 4 is a block diagram illustrating selected elements of an equalizer that is to compensate for the phase characteristics of a VCSEL in an optical transmitter, according to at least some embodiments. In this example, equalizer 400 includes a low-pass filter 410 in parallel with an all-pass filter 420. An input signal (shown as Dᵢₙ) is directed to the input of low-pass filter 410 and to the input of all-pass filter 420. The output signal 415 of low-pass filter 410 and the output signal 425 of all-pass filter 420 are directed to a combiner circuit 430. In various embodiments, the output of the equalizers disclosed herein may be generated as a linear combination of the outputs of the individual filter elements. In the example embodiment illustrated in FIG. 4, the combiner circuit 430 may generate an output of equalizer 400 (shown in FIG. 4 as Dₒᵤₜ) as the difference between output signal 415 of low-pass filter 410 and output signal 425 of all-pass filter 420. More specifically, combiner circuit 430 may be implemented to subtract the all-pass filter output 425 from the low-pass filter output 415 to generate Dₒᵤₜ.

The output signal Dₒᵤₜ may be directed to the input of a VCSEL, and may compensate for at least a portion of the phase characteristics of the VCSEL, in some embodiments. In some embodiments, the bandwidth for the all-pass filter may be approximately one-half of the bandwidth of the input signal (e.g., one-half of the data rate of the optical transmitter). In some embodiments, the bandwidth for the low-pass filter may be less than the bandwidth for the all-pass filter.

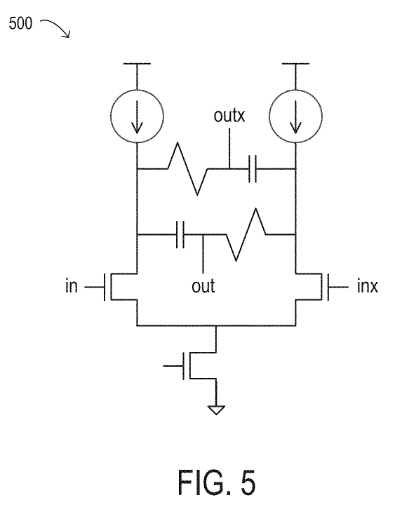

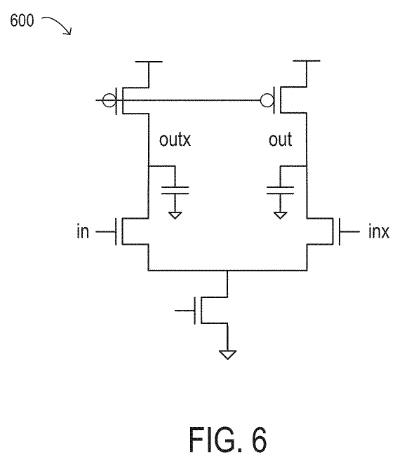

FIG. 5 is a block diagram illustrating an example implementation of an all-pass filter circuit that may be included in the equalizers described herein, according to at least some embodiments. While some all-pass filters may be well suited for use with relatively low frequencies, the all-pass filter circuit illustrated in FIG. 6 may be well suited for use with higher frequencies. In this example, all-pass filter circuit 500 includes differential inputs (which are labeled as in and inx, respectively), and the output is taken differentially from the two middle points (which are labeled as out and outx, respectively). In this example, the two resisters have substantially the same value and the two capacitors have substantially the same value. In order to change the frequency range at which the all-pass filter operates, the values of these resistors and/or capacitors may be modified (e.g., to change the RC constants of the all-pass filter circuit 500). Note that, in at least some embodiments, the phase shift that is applied by the all-pass filter may be set and/or changed by manipulating various circuit parameters of the all-pass filter circuit.

FIG. 6 is a block diagram illustrating an example implementation of a low-pass filter circuit that may be included in the equalizers described herein, according to at least some embodiments. In this example, low-pass filter circuit 600 includes differential inputs (which are labeled as in and inx, respectively), and the output is taken differentially from the two middle points (which are labeled as out and outx, respectively). The values of the capacitors on the differential outputs may be substantially the same. Note that, in general, any circuit may include some amount of paralytic capacitance and may behave, to some extent, as a low-pass filter. Therefore, some embodiments of the equalizers described herein may not include a dedicated low-pass filter circuit. However, a circuit that is designed to function as a low-pass filter may include at least a register and a capacitor, which may be sufficient to provide this functionality, in some embodiments. In other embodiments, the low-pass filter circuit that is included in the equalizers described herein may be and inductive low-pass filter, rather than a capacitive low-pass filter.

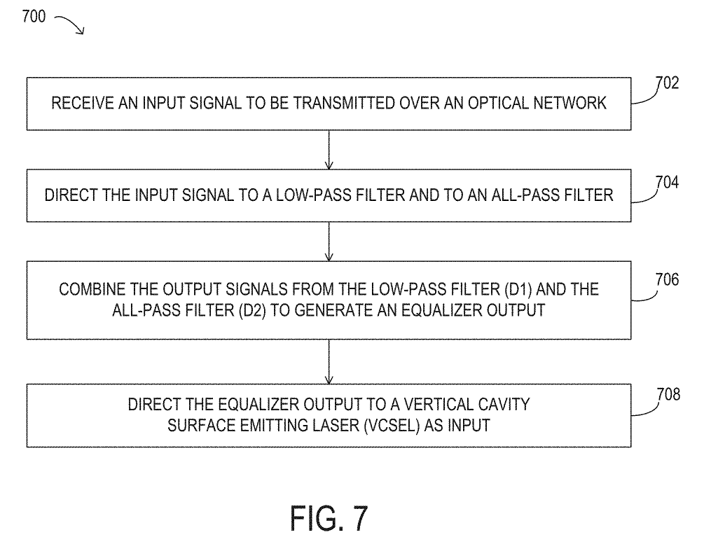

The method of operation for the phase-compensating equalizers disclosed herein may be similar regardless of the specific filter circuitry used to implement them. For example, FIG. 7 is a flow diagram illustrating selected elements of a method of operation 700 of a phase-compensating equalizer that includes both a low-pass filter and an all-pass filter, according to at least some embodiments. As illustrated at step 702, in this example, the method may include receiving an input signal that is to be transmitted over an optical network. The method may also include, at step 704, directing the input signal to the input of a low-pass filter and to the input of an all-pass filter.

As illustrated in FIG. 7, the method may include, at step 706, combining the output signal from the low-pass filter (D1) and the output signal from the all-pass filter (D2) to generate an equalizer output. As described herein, the equalizer output may be generated as a linear combination of these outputs (e.g., as D1-D2), in some embodiments. As illustrated at step 708, the method may include directing the equalizer output to a vertical cavity surface emitting laser (VCSEL) as input.

In some cases, an initial design of a phase-compensating equalizer may (e.g., based on the results of simulation or prototyping) be modified to better compensate for the phase characteristics of the particular VCSEL in an optical transmitter and/or for other characteristics of the optical transmitter, the optical communication network, and/or the input signals to be transmitted in the optical communication network.

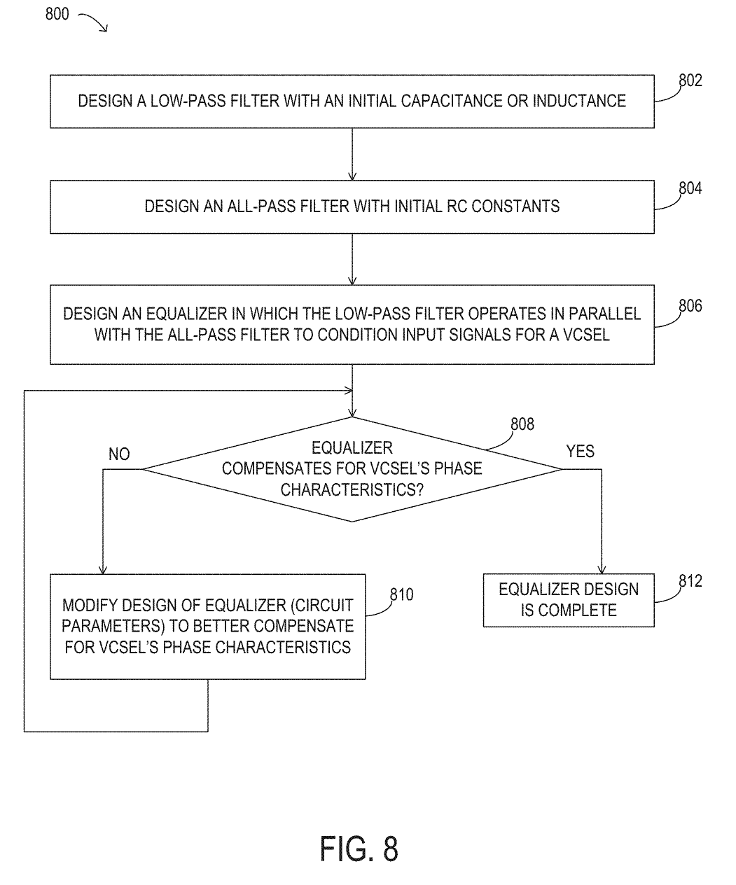

FIG. 8 is a flow diagram illustrating selected elements of a method 800 for designing an equalizer that compensates for the phase characteristics of a VCSEL in an optical transmitter, according to at least some embodiments. As illustrated at step 802, in this example, the method may include designing a low-pass filter having initial circuit parameter that include a given initial capacitance and/or inductance (depending on the type of low-pass filter). The method may include, at step 804, designing an all-pass filter having initial circuit parameter that include initial RC constants (e.g., an initial pair of RC constants for each of the two output paths of a differential all-pass filter). The method may also include, at step 806, designing an equalizer in which the low-pass filter operates in parallel with the all-pass filter to condition input signals for a VCSEL.

As illustrated at decision block 808, the method may include determining (e.g., through simulation and/or prototyping of the equalizer circuit and/or an optical transmitter that includes the equalizer and a VCSEL) whether the equalizer adequately compensates for the inherent phase characteristics of the VCSEL. For example, the method may include determining whether or not a target metric for reducing the phase distortion introduced by the VCSEL (e.g., in terms of a percentage of the distortion or a specified (absolute) reduction in an explicit measurement of the phase distortion) is met. If it is determined that the equalizer does not adequately compensate for the inherent phase characteristics of the VCSEL, the method may include, at step 810, modifying the design of the equalizer (adjusting various circuit parameters, such as the RC constants of the all-pass filter and/or the capacitance/inductance of the low-pass filter) to better compensate for the inherent phase characteristics of the VCSEL.

As illustrated in this example, step 810 may be repeated one or more times until the equalizer adequately compensates for the inherent phase characteristics of the VCSEL. If, or once, the equalizer adequately compensates for the inherent phase characteristics of the VCSEL, then at 812, the design of the equalizer may be complete.

In some embodiments, the equalizers disclosed herein (e.g., equalizers that implement phase equalization for an optical transmitter that includes a VCSEL) may be used in optical communication networks in which an input signal that is to be transmitted encodes information at three or more analog levels. For example, an input signal encoded using PAM4 may, rather than representing a series of single bits (zeros and ones), represent a pair of bits using four analog signal levels. In this example, the lowest amplitude signal level may represent an encoding of 00, the next lowest amplitude signal level may represent an encoding of 01, and so on.

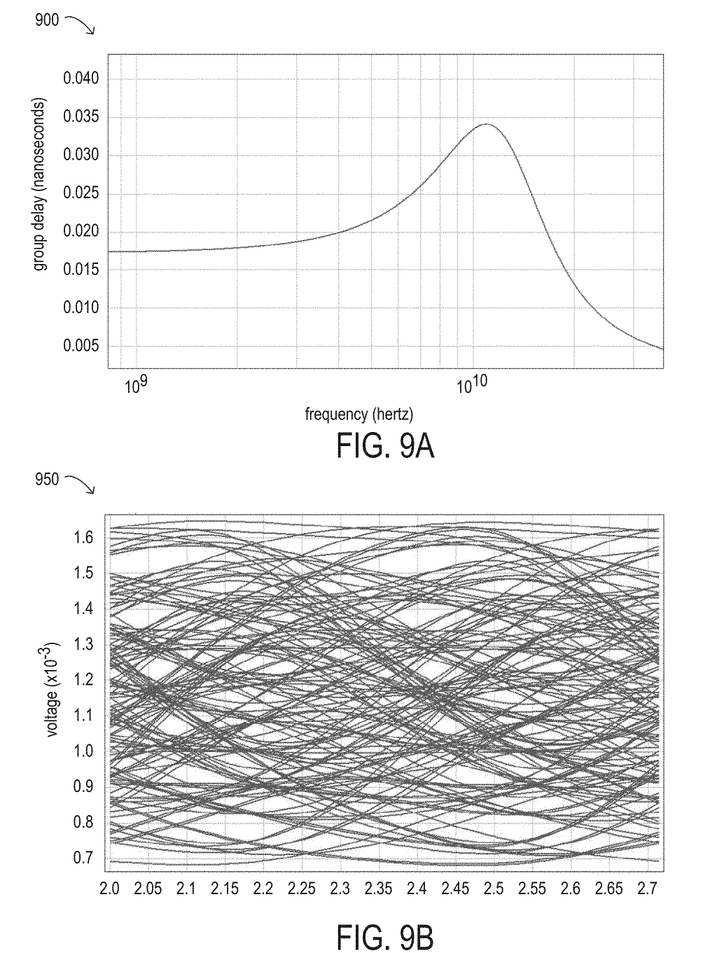

As noted above, FFEs are often used in transmitters that include VCSELs. However, these types of linear equalizers may not adequately address phase distortion that is due to the phase characteristics of the VCSELs. FIGS. 9A and 9B illustrate example responses of a VCSEL for an unequalized PAM4 input signal at 56 gigabits per second. For example, FIG. 9A includes a graph 900 illustrating the frequency response of the VCSEL when it is driven by this input signal without phase equalization. More specifically, the y-axis of graph 900 represents the VCSEL output group delay (which is a function of the phase characteristics of the VCSEL), and the x-axis represents a range of frequencies. A group delay that is fixed (constant) over the frequency range of interest may produce the least distortion. However, if the group delay is not fixed (as in this example), this may indicate that some components of the signal are faster than other components of the signal, and that the signal will be distorted.

In some cases, if the input to the VCSEL is unequalized, this phase distortion may result in an eye that is largely (or completely) closed. In such cases, it may be difficult, if not impossible, to glean any meaningful information from the VCSEL output. FIG. 9B illustrates an eye diagram 950 for such a case, e.g., when driving the VCSEL with an unequalized PAM4 signal at 56 gigabits per second.

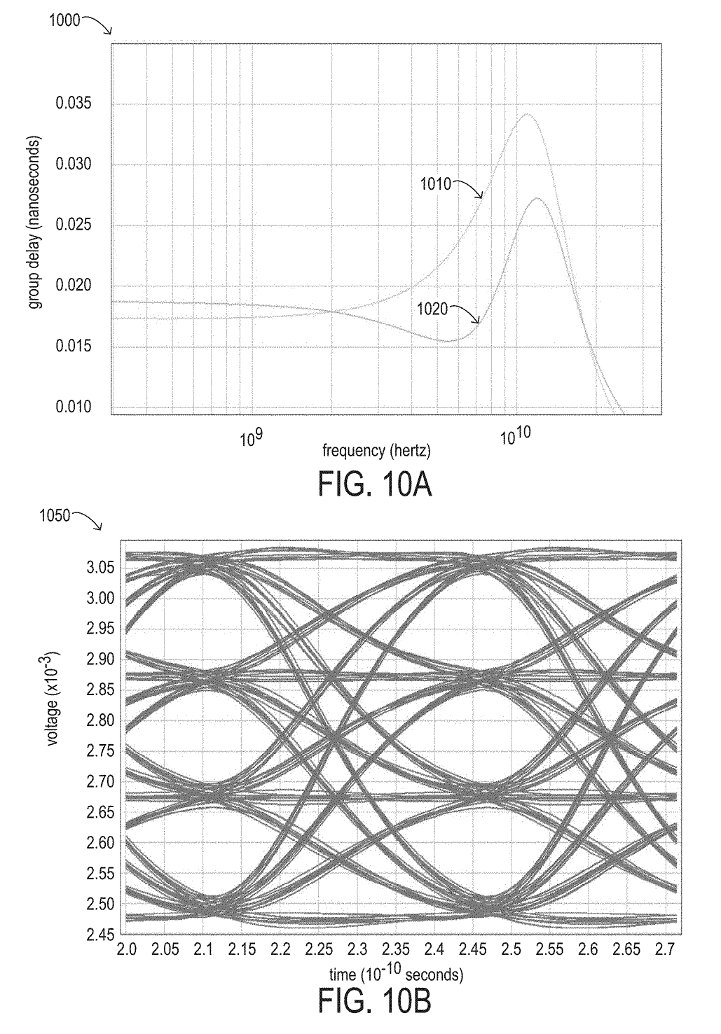

FIGS. 10A-10B illustrate an example of the effects of the phase equalization techniques disclosed herein on the response of a VCSEL for a PAM4 input signal at 56 gigabits per second. FIG. 10A includes a graph 1000 illustrating the frequency response of the VCSEL when it is driven by this input signal with phase equalization and without phase equalization. More specifically, the y-axis of graph 1000 represents the VCSEL output group delay (which is a function of the phase characteristics of the VCSEL), and the x-axis represents a range of frequencies. The frequency response labeled as 1010 on graph 1000 depicts the response without phase equalization, while the frequency response labeled as 1020 on graph 1000 depicts the response with phase equalization. As illustrated in this example, by applying the phase equalization techniques disclosed herein (e.g., by passing the input signal through an equalizer that includes both a low-pass filter and an all-pass filter), the group delay may be significantly improved over the unequalized case. While the group delay in the equalized case is still not ideal (i.e., it is not completely constant), in this example, the variation in the group delay was reduced by approximately 50%.

FIG. 10B illustrates an eye diagram 1050 for such a case, e.g., when driving the VCSEL with a phase equalized PAM4 signal at 56 gigabits per second. As illustrated in this example, applying the phase equalization techniques disclosed herein (e.g., by passing the input signal through an equalizer that includes both a low-pass filter and an all-pass filter) may produce a much cleaner eye diagram than that produced in the unequalized case.

Note that while FIG. 5 and FIG. 6 illustrate specific circuits that may implement the all-pass filtering and the low-pass filtering of a phase-compensating equalizer, respectively, in other embodiments, any of a variety of filtering circuits that implement the functionality of an all-pass filter and/or a low-pass filter may be included in the phase-compensating equalizer instead of the filter circuits illustrated in FIG. 5 and FIG. 6.

Note also that, rather than constructing a phase-compensating equalizer from two individually-designed filter circuits (e.g., a low-pass filter and an all-pass filter), it may be possible to design a single filter that includes the functionality of the phase-compensating equalizers described herein (e.g., a single filter whose transfer function is equivalent to the combination of the transfer functions of the two individual filter circuits). In some embodiments of the present disclosure, a single filter circuit that is designed based on the characteristics of the combination of the two individual filters may apply two types of filtering operations (e.g., low-pass filtering and all-pass filtering) in a single filtering stage (which may have the same effect as applying two individual filters in parallel) or in multiple filtering stages. In the present disclosure, references to a low-pass filter or to an all-pass filter may apply to the low-pass filtering portion of single filter or to an all-pass filtering portion of a single filter, respectively.

As previously noted, the output of a phase-compensating equalizer may be generated as a linear combination (e.g., through addition or subtraction) of the respective outputs of a low-pass filter and an all-pass filter. However, the weighting of the outputs may or may not be equal, in different embodiments. For example, in some embodiments, there may be an inherent weighting of these two outputs that is dependent on the relative gains of the two filters, and no additional weighting may be applied by the combining circuit or by any element that conditions them as inputs to the combining circuit. In such embodiments, the weighting may be changed by modulating the gains of the two filters.

Note that, in some embodiments, an optical transmitter that includes a VCSEL and a phase-compensating equalizer may also include one or more other types of equalizers. In addition, and optical network that includes one or more equalizers in its transmitters (including a phase-compensating equalizer) may also include one or more equalizers of various types in its receivers.

In some examples, one possible input signal to the phase-compensating equalizer was described as a pulse-amplitude modulated (PAM) signal with four analog levels representing two bits of information. However, the phase-compensating equalizers described herein may also be used to improve the performance of an optical transmitter that includes a VCSEL when it is presented with other types of input signals, including more or less complex signals having any number of levels. For example, the phase-compensating equalizers described herein may improve the performance of an optical transmitter that includes a VCSEL regardless of the type of modulation and/or encoding scheme that was applied to generate the input signal. In some embodiments, the phase-compensating equalizers described herein may improve the performance of an optical transmitter in an optical communication network that employs one or more of phase-shift keying (PSK), frequency-shift keying (FSK), amplitude-shift keying (ASK), pulse-amplitude modulation (PAM), quadrature amplitude modulation (QAM), non-return-to-zero (NRZ) modulation, return-to-zero (RZ) modulation, or any suitable variants of these and other modulation techniques.

As disclosed herein, a phase-compensating equalizer may, in at least some embodiments, be implemented using a relatively simple structure that include an all-pass filter and a low-pass filter that operate in parallel to compensate for the phase characteristics of a VCSEL. The phase-compensating equalizer may be implemented entirely in the analog domain (e.g., using analog circuits) and without introducing a transport delay. The phase-compensating equalizer may be scalable to very high data rates (e.g., on the order of tens of gigabits per second and beyond), and may not introduce additional phase distortion.

In various embodiments, the methods and systems for phase-compensating equalization disclosed herein may be implemented in high performance enterprise servers and routers, or, in general, in any type of telecommunication equipment or system that implements optical transmission at high speeds. For example, while FIG. 1 illustrates an optical network that may typically be used for long haul optical communications, in other embodiments, the phase-compensating equalizers described herein may also be used for short reach optical interconnects (e.g., interconnects within a single rack). In various embodiments, these phase-compensating equalizers may, by applying both low-pass filtering and all-pass filtering to an input signal to be transmitted in an optical communication network, compensate for at least some of the phase distortion caused by the VCSELs that receive the outputs of these equalizers. For example, they may improve the phase responses of VCSELs even when operating at very high data rates, thus improving the performance of the optical transmitters in which they co-exist with those VCSELs.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A phase-compensating equalizer, comprising:
a low-pass filter to allow input signals having a frequency lower than a cutoff frequency to pass through the low-pass filter without attenuation, to attenuate input signals having a frequency higher than the cutoff frequency, and to generate, from a first input signal, a first intermediate output signal;
an all-pass filter to alter phase characteristics of input signals without altering amplitude characteristics of the input signals, and to generate, from the first input signal, a second intermediate output signal whose amplitude characteristics are not dependent on frequency; and
a combining circuit to generate an output signal for the phase-compensating equalizer as a linear combination of the first intermediate output signal and the second intermediate output signal.

2. The phase-compensating equalizer of claim 1,
wherein the first input signal is to be transmitted in an optical communication network.

3. The phase-compensating equalizer of claim 1,
wherein to generate the output signal of the phase-compensating equalizer, the combining circuit is to subtract the second intermediate output signal from the first intermediate output signal.

4. The phase-compensating equalizer of claim 1,
wherein the low-pass filter and the all-pass filter are implemented by respective analog circuits.

5. The phase-compensating equalizer of claim 1,
wherein the all-pass filter is to add a varying amount of delay to the second intermediate output signal, wherein the amount of the delay varies as a function of the frequency of the first input signal.

6. The phase-compensating equalizer of claim 1,
wherein the low-pass filter is implemented by a capacitive low-pass filter circuit.

7. The phase-compensating equalizer of claim 1,
wherein the low-pass filter is implemented by an inductive low-pass filter circuit.

8. The phase-compensating equalizer of claim 1,
wherein the output of the phase-compensating equalizer is an input to a vertical cavity surface emitting laser (VCSEL).

9. The phase-compensating equalizer of claim 8,
wherein the phase-compensating equalizer is to compensate for phase distortion introduced by the VCSEL.

10. An optical transmitter, comprising:
a phase-compensating equalizer to perform a low-pass filtering operation and an all-pass filtering operation on an input signal and to generate an output signal; and
a vertical cavity surface emitting laser (VCSEL);
wherein the output signal of the phase-compensating equalizer is directed to the VCSEL as input.

11. The optical transmitter of claim 10,
wherein the phase-compensating equalizer comprises:
a first analog filter circuit to perform the low-pass filtering operation and to generate a first intermediate output signal;
a second analog filter circuit to perform the all-pass filtering operation and to generate a second intermediate output signal; and
a combining circuit to generate the output signal as a linear combination of the first intermediate output signal and the second intermediate output signal.

12. The optical transmitter of claim 11,
wherein to generate the output signal, the combining circuit is to subtract the second intermediate output signal from the first intermediate output signal.

13. The optical transmitter of claim 11,
wherein the first analog filter circuit is to allow input signals having a frequency lower than a cutoff frequency to pass through the low-pass filter without attenuation and to attenuate input signals having a frequency higher than the cutoff frequency.

14. The optical transmitter of claim 11,
wherein the second analog filter circuit is to add a varying amount of delay to the second intermediate output signal, wherein the amount of the delay varies as a function of the frequency of the input signal.

15. The optical transmitter of claim 10,
wherein the phase-compensating equalizer comprises a single analog filter circuit whose transfer function is equivalent to a combination of the respective transfer functions of a low-pass filter and an all-pass filter that operate in parallel.

16. The optical transmitter of claim 10,
wherein the phase-compensating equalizer compensates for phase distortion introduced by the VCSEL.

17. The optical transmitter of claim 10,
wherein the phase-compensating equalizer is one of a plurality of equalizers that condition the input signal.

18. A method for phase equalization, comprising:
designing a low-pass filter having initial circuit parameters, wherein the initial circuit parameters of the low-pass filter comprise an initial capacitance or inductance;
designing an all-pass filter having initial circuit parameters, wherein the initial circuit parameters of the all-pass filter comprise one or more initial RC constants;
designing a phase-compensating equalizer in which the low-pass filter and the all-pass filter operate in parallel to condition an input signal and in which an output is generated as a linear combination of respective intermediate outputs generated by the low-pass filter and the all-pass filter.

19. The method of claim 18, further comprising:
determining that the phase-compensating equalizer does not meet a target metric for compensating phase distortion introduced by a vertical cavity surface emitting laser (VCSEL); and
modifying, in response to said determining, one of the initial circuit parameters of the low-pass filter or one of the initial circuit parameters of the all-pass filter.

20. The method of claim 18, further comprising:
receiving, by the phase-compensating equalizer, an input signal to be transmitted over an optical network;
directing the input signal to a low-pass filter;
generating, by the low-pass filter, a first intermediate output signal;
directing the input signal to an all-pass filter;
generating, by the all-pass filter, a second intermediate output signal;
subtracting the second intermediate output signal from the first intermediate output signal to generate an output signal for the phase-compensating equalizer; and
directing the output signal to a vertical cavity surface emitting laser (VCSEL) as input.
